(19) United States
(12) Patent Application Publication
(10) Pub. No.: US 2005/0139746 A1
(43) Pub. Date: Jun. 30, 2005

(54) Book holder

(76) Inventor: Loren Gene Morris, Denver, CO (US)

Correspondence Address: LOREN MORRIS, 9032 E. MANSFIELD AVE., DENVER, CO, 80237, US

(21) Appl. No.: 11/004,267

(22) Filed: Dec. 3, 2004

Related U.S. Application Data
(60) Provisional application No. 60/532,688, filed on Dec. 24, 2003.

(51) Int. Cl. B42D 9/00

(52) U.S. Cl. 248/441.1

(57) ABSTRACT

A holder specifically designed to be created for multiple size books. To cover, protect and carry “hands-free” the book for the user. To be customized by the user or merchant. To not hinder the user's motion. To provide a handy holder for personal books when free time to read occurs throughout the day.

### CROSS-REFERENCE TO RELATED APPLICATIONS

Application No. 60/532,688

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a personal book holder, specifically to a handsfree book holder designed to be attached to a belt or waistband of a user's clothes.

### BACKGROUND OF THE INVENTION

This invention relates to a personal book holder. More specifically, the present invention relates to a portable book holder designed to be attached to a belt or waistband of a user's clothes. It is designed to be unobtrusive to the user and keep a book handy for the user when it may be needed. There are many times and places where a personal book for pleasure reading would be beneficial to a user, especially allowing a “hands-free” carrying method. To both read the book for enjoyment during un-pleasurable waits, and to allow time to pass when there is nothing else available to occupy the user.

There are numerous U.S. patents which describe characteristics of a singular purpose personal item holder. U.S. Pat. No. 2,812,891 (1957) to Carlson et al describes a personal ashtray. This ashtray exhibits an unobstructed triangular pouch to catch cigarette ashes. This design is economical for its intended use for ashes, however this design is not practical for books or other rectangular items. U.S. Pat. No. 3,294,298 (1966) to Danielson describes a personal hammer holder. U.S. Pat. No. 4,746,042 (1988) to King describes a personal paintbrush holder. U.S. Pat. No. 5,501,382 (1996) to Webb describes a personal universal hand tool holder. U.S. Pat. No. 6,227,406 B1 (2001) to Herlacher describes a pouch to hold a label dispenser. All of the above listed patents describe a pouch or holder of some kind. None of these previous patents address books as a primary object to be held in the item. While any of the five designs may be adjusted for the use of carrying a book, it is not an obvious adjustment. Also it is not obvious as to which part or parts need to be adjusted to accommodate a book. Also a couple of the designs show a rigid material being used for the pouch which would limit the users mobility and become an obstruction during use.

There are many items available to simply protect and cover paperback books for users. For example U.S. Pat. No. 3,933,375 (1976) to Humphrey, U.S. Pat. No. 4,274,659 (1981) to McHugh, U.S. Pat. No. 4,497,508 (1985) to McHugh, U.S. Pat. No. 4,615,541 (1986) to Kwauka, U.S. Pat. No. 4,846,500 (1989) to Klang, U.S. Pat. No. 5,029,900 (1991) to Axelrod, U.S. Pat. No. 5,474,332 (1995) to Yeh, U.S. Pat. No. 5,622,385 (1997) to Yeh, U.S. Pat. No. 5,992,886 (1999) to Udd. The main drawback, that all these designs exhibit, is that they do not provide a carrying method of any sort for the user.

There are also a few items designed to protect, cover and carry paperback books. For example U.S. Pat. No. 4,036,417 (1977) to Traphagan provides cover for a book with simple carrying handles incorporated into the sides of the protective cover. However, for readers of books it can be desirable to have a book carrying method that is “hands-free”, which would make this particular design to be unacceptable for many readers. There are also “hands-free” carrying designs available. The most common design is the “fanny pack”, which unfortunately is not large enough to carry a paperback book. Also there is the chance that should a user fit a book in a “fanny pack” they run the risk of breaking the spine of the book since the pack was not originally designed to carry or protect the book. Also there is U.S. Pat. No. 6,293,445 (2001) to Miller, which describes a belt pack to carry small items such as “glasses, a wallet, pocket change, tissues and the like”, the description does not mention that the pack is large enough to fit a paperback book without damage, or that the pack has the capability to be re-sized to fit a paperback book.

As mentioned above each prior art design has an inherent disadvantage that limits each items ability to protect, cover and carry “hands-free” a paperback book.

### BACKGROUND OF INVENTION—OJECTS AND ADVANTAGES

Several objects and advantages of the present invention are:
A. To cover and provide protection from unnecessary damage to a paperback book for the user.
B. To provide an unobtrusive “hands-free” method for carrying a paperback book.
C. To provide a design that allows easy removal of the paperback book for the user.
D. To provide a design specifically for paperback books that is easily adjusted in manufacturing to accommodate various sizes of paperback books and various belt and waist conditions on users.
E. To provide a design that is easily customized by the user or merchant.
F. To provide a design that is inexpensive and easily manufactured to allow more users to benefit from their unplanned free time and encourage more users, even students at schools, to read more often.

Still further Objects and advantages will become apparent from a consideration of the ensuing description and drawings.

### SUMMARY

In accordance with the present invention a book holder, as a new use for a personal pouch with a unique design, comprises vertical straps at the back, which are continuous to the bottom to allow a book to be dropped in with no damage to the cover, and solid material on the front and sides to protect and carry a paperback book “hands-free”.

### DRAWINGS

FIG. 1: Plan view of the one piece of material that makes the front, sides and bottom of the book holder. It can be seen that it would be easy to provide a picture sleeve or logo on the front of the material or customization by the user or merchant.

FIG. 2: Perspective view showing the book holder at an initial stage of fabrication. Here it is possible to see that the vertical straps on the rear at each side are continuous and uninterrupted from the top to the bottom. This continuity prevents damage to the paperback book when it is dropped into the holder. It is also possible to see how the one piece of material folds to create the protective front, bottom and sides of the holder.

FIG. 3: Front view of the book holder constructed in accordance with the description.

FIG. 4: Side view of the book holder in FIG. 3.

FIG. 5: Rear view of the book holder in FIG. 3. The hidden line on the top of the upper horizontal strap is the depression in the front panel behind.

FIG. 6: Isometric front view of the book holder in FIG. 3.

FIG. 7: Isometric rear view of the book holder in FIG. 3.

DETAIL A: shows a couple of the possible belt connections that can be used. Either the vertical straps can be folded over and sewn to make loops or the vertical straps can be sewn to a belt hook. Another method not shown would be to add a belt directly to the design to assist the users who do not wear belts.

### DETAILED DESCRIPTION

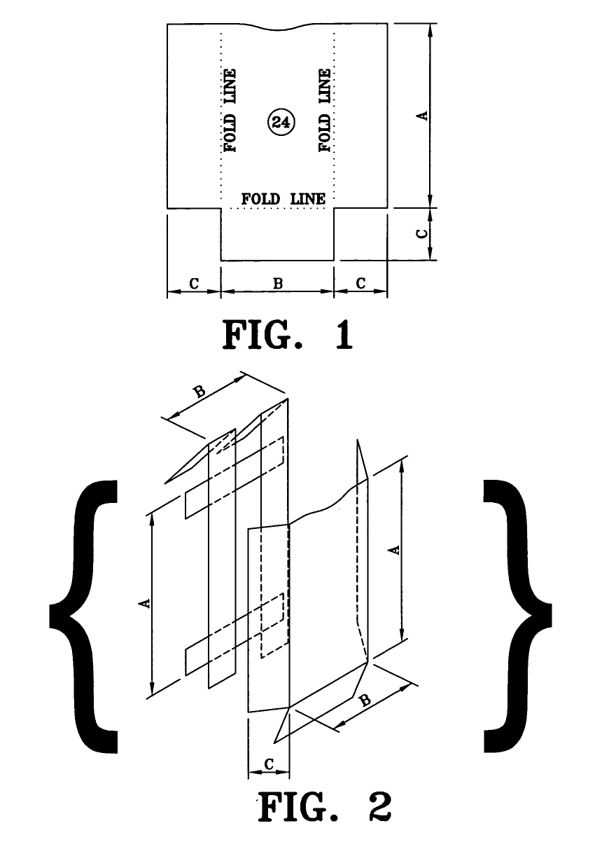

The dimensions shown in the drawings can be manufactured for many different sizes of books by changing only a few dimensions. FIG. 1 shows the three main dimensions used in creating the holder. Dimension A is the height of the book to be placed in the holder. Dimension B is the width of the book to be placed in the holder. Dimension C is the thickness of the book to be placed in the holder. This simple one main piece construction allows for easy adjustment in the manufacturing process to accommodate many different size holders for many different sizes of books.

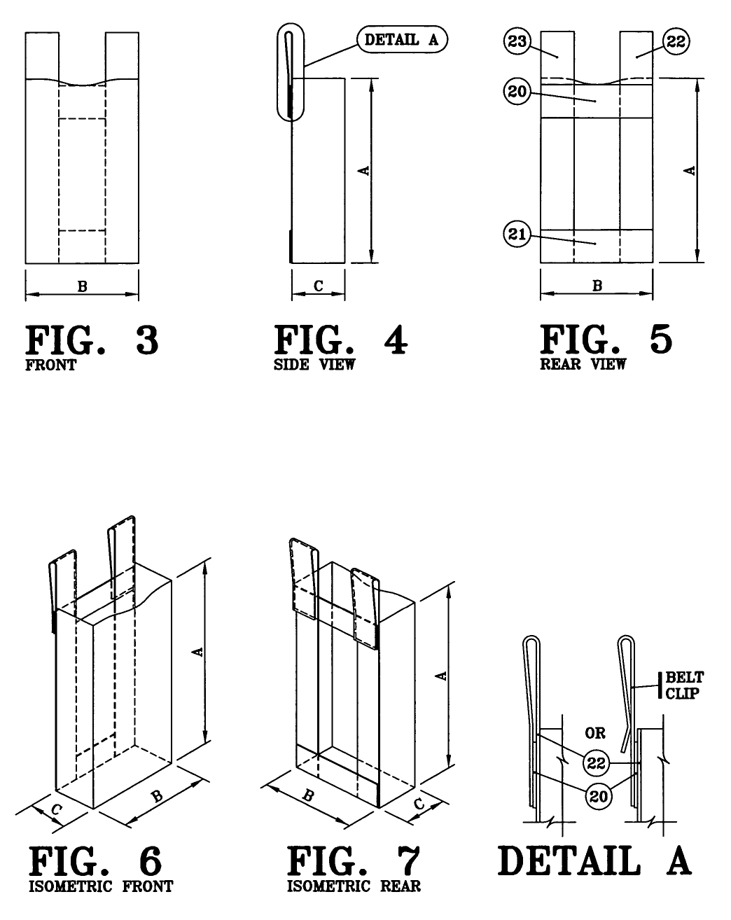

FIG. 3 is a front view showing the front of part 24 after it has been folded. Part 24 is cut to a size, as shown in FIG. 1., of dimensions A+C by B+2C the bottom corners of the piece are removed by a dimension of C×C squares. This allows part 24 to become the front, bottom and sides of the holder to allow for the minimum number of seams and easier construction and adjustment.

FIG. 5 shows the back of the holder showing two (2) horizontal straps, dimension B in length, which create the top and bottom of the rear of the holder (parts 20 and 21). Connected to the two (2) horizontal straps mentioned above are two (2) vertical straps, which are the only variably dimensioned items, dependant on the belt attachment (parts 22 and 23). As can also be seen in FIG. 5, the top of part 20 to the bottom of 21 is also dimension A. The horizontal straps are on the outside face of the vertical straps and therefore on the outside of the holder, allowing the vertical straps 22 and 23 to be continuous from top to bottom on the inside of the holder. These two (2) continuous straps create a straight surface in contact with the book and help prevent damage to the book.

By changing Dimension A, B, and C, the manufacturer can create the holder for many different size books for many different uses. Dimension A is the height of the book. Dimension B is the width of the book. Dimension C is the thickness of the book.

### REFERENCE NUMERALS

20 Top horizontal strap in back of holder
21 Bottom horizontal strap in back of holder
22 Right vertical strap in back of holder
23 Left vertical strap in back of holder
24 One piece front, sides and bottom of holder.

### OPERATION

The manner of using the book holder to cover, protect and carry (hands-free) a book for the user is as simple as attaching the holder to the belt of the user, or clipping a provided belt around the users waist. The holder is designed to move with the user and be no hindrance to the user's everyday movements or activities. The user merely places the book in the holder to keep it covered, protected and carried “hands-free” for availability and use throughout the day.

### CONCLUSION, RAMIFICATIONS AND SCOPE

Accordingly, the reader will see that the “Book Holder” is designed specifically to cover, protect and carry a paperback book for the user.
It permits an unobstructive “hands-free” method for carrying a paperback book for a user.
It is designed for quick removal of the paperback book from the holder.
It is designed to be easily adjusted at the manufacturing level to accommodate various sizes of paperback books.
It is designed to be easily customized by the user or the merchant.
It is designed to be inexpensive and easily manufactured to allow the maximum number of users to benefit from the pleasures of reading.

Although the points above contain many specificities, these should not be considered as limiting the scope of the intention but as merely providing illustrations of some of the presently preferred embodiments of this invention. For example, the design can be created without rear straps or with various other more, or less, rigid materials to satisfy users, or even to add a strap across the top to hold the book in the holder.

Thus the scope of the invention should be determined by the appended claims and their legal equivalents, rather than by the examples given.

1: A portable book holder for carrying a paperback book on the person of the reader, attachable to the belt or waist of the reader by attachment means, said portable book holder comprising:
(a) a bottom rectangular surface, vertical rectangular front wall, vertical opposing rectangular sidewalls, continuously uninterrupted vertical rear surface forming a rectangular enclosure defining a receptacle having an open top for receiving and snugly fitting a paperback book for carrying and without causing damage to said paperback book;
(b) single attachment means for attaching the book holder to the belt of the reader wherein said attachment means is located on exterior surface of the book holder adjacent to the person of the reader and comprises, loops to thread the belt of the reader through, downwardly opening spring clips having an inverted U-shaped closed top loop portion, or a single strap belt provided with the holder.
